(19) United States
(12) Patent Application Publication
(10) Pub. No.: US 2007/0283674 A1
(43) Pub. Date: Dec. 13, 2007

(54) Multi-functional tractor attachment assembly for conditioning land

(76) Inventor: Jerry Watkins, Johnston City, IL (US)

Correspondence Address: ROBERT M. PATINO, 1901 S. PASFIELD, SPRINGFIELD, IL, 62704, US

(21) Appl. No.: 11/804,356

(22) Filed: May 18, 2007

Related U.S. Application Data
(60) Provisional application No. 60/801,733, filed on May 19, 2006.

(51) Int. Cl. A01D 34/30

(52) U.S. Cl. 56/257

(57) ABSTRACT

A tractor attachment assembly releaseably connected to a front end of a work vehicle for conditioning land. The tractor attachment assembly is multi-functional because, among other things, it is capable of clearing small trees and shrubs while being able to roll soil and place grooves into the ground for land conditioning. The tractor attachment assembly is provided with an at least one toothed plate and a sub-plate for supporting the at least one toothed plate. The sub-plate is preferably provided with a nut and bolt disengagement mechanism to release the at least one toothed plate from the sub-plate. The tractor attachment assembly is also provided with a framed connection member that is connectable to the front end of the work vehicle and positioned to support the sub-plate when the sub-plate is under stress.

### CROSS-REFERENCE TO RELATED APPLICATION

This application claims the benefit of U.S. Provisional Patent Application No. 60/324,234, filed Aug. 2, 2006, the entire disclosure of which is incorporated herein.

### BACKGROUND OF THE INVENTION

The present invention relates to a tractor attachment assembly usable on a work vehicle for conditioning land, and more particularly to such a tractor attachment assembly used interchangeably with tractors and like vehicles as a front-end loader to clear brush, remove trees and rake soil such that the land is conditioned and quickly prepared for land cultivation or improvement projects.

Tractors are frequently employed to prepare an area for development. Areas that contain a lot of plants, brush or even debris offer many challenges to professionals and landowners that consider using tractors to clear an area of land. Tractors or small work vehicles such as the bobcat are the vehicles of choice because of the power that they offer and their ability to negotiate difficult terrain. In most instances, tractors and work vehicles employ a front loaded bucket to remove small trees and brush. The advantage of the front loaded bucket is that it is capable of providing a lot of power with the weight of the tractor behind it and consists of a large scoop component capable of moving a large quantity of material. One problem associated with these types of front loaded attachment assemblies is that they typically weigh several hundred pounds and require multiple persons to help remove and replace each attachment assembly. On a normal project to condition the ground, several separate attachments may be required.

To help accommodate the inconvenience of changing front loaded attachment assemblies, new quick release mechanisms have been developed and are found on the majority of smaller tractors and bobcats allow for quick interchanging between attachment assemblies. However, the attachment assembly of choice for doing most of the work is the front loaded bucket design.

Several disadvantages reside with the use of the front loaded bucket design when attempting to condition land. While the front loaded bucket is successful the majority of the time in taking down small trees and shrubs, roots are often left intact that require digging and time in order to remove. Buckets are also not provided with triangle shaped teeth to grip the small trees or shrubs. If loosened trees, shrubs or similar types of debris are not cleanly caught by the bucket, they can be difficult to transport to a removal container. Furthermore, once debris is successfully loaded onto the front loaded bucket, the buckets are not provided with a safety feature to protect the driver of the tractor from falling debris when the front loaded bucket is raised above the driver's head.

The front loaded buckets used to remove small trees and brushes are also used to even out small piles of dirt or ground material such as rocks or sand. Clumps of dirt or ground material are loaded onto the buckets and then spread throughout an area and flattened. Although the buckets are capable of removing or evening out the small piles of dirt effectively, once the land is cleared of debris, the front loaded buckets are not provided with a means of rolling the soil forward to allow for quick leveling of the uneven ground or soil.

Furthermore, the buckets lack a means of conditioning the ground once the small pile has been leveled in a forward or reverse manner. Once the trees and shrubs have been dug up and refilled, a box blade or similar attachment is typically attached on the rear end of the tractor and run off a 3-point hitch to condition the ground or soil. Blades found on the underside of the box blade are run into the ground to produce groves and even the soil. The drawback to this box blade attachment is that the maximum energy it can transfer in a vertical direction into the ground is limited by the weight of the box blade itself. When the soil is made of a variation in composition, such as clay, sand and top soil, uneven conditioning takes place as the blades are forced to retreat when the density in the ground changes. The additional required operations are time consuming and result in a large consumption of fuel and energy to get a brush clearing task completed.

Therefore, it is desired to have an attachment assembly that is capable of clearing land in an efficient and effective manner that can be releaseably attached to a tractor or work vehicle. The attachment assembly should preferably be provided with means of gripping small trees, shrubs and small debris and a safety shield or brush guard to protect drivers from falling debris when raised above the driver's head. Furthermore, it is desired that such an attachment assembly be provided with a means of rolling dirt, soil or ground material in a forward motion while using a work vehicle and be able to condition the ground in either direction of operation.

Thus, there is a need for an attachment assembly capable of driving out small trees and shrubs and also capable of conditioning the ground. The attachment assembly needs to usable on quick release front loaded vehicles and be sturdy enough to withstand the stresses associated with land clearing and conditioning. Furthermore, there is a need for such an attachment assembly to safely break off tooth engraved plates such that damage is avoided to the other parts of the attachment assembly. Damaged tooth engraved plates can be quickly replaced with new or refurbished plates to quickly resume the work started by the work vehicle. There is also a need for a safety shield on such an attachment assembly that protects the driver of the work vehicle when it is transporting debris to other cites or the attachment assembly itself is raised above the work vehicle. Moreover, the attachment assembly should preferably be provided with a means of rolling the loose material on the ground when the work vehicle is advancing in a forward motion.

### BRIEF SUMMARY OF THE INVENTION

The above-identified needs are addressed by the present attachment assembly usable on a work vehicle for conditioning land. One feature of the present invention is an at least one toothed plate. The toothed plate is capable of slicing through small trees and shrubs and with the attachment assembly angled to scoop up the loose brush, the toothed plate also provides a means of gripping onto the loose brush for removal. The toothed plate also acts as a land conditioning tool that is able to carve grooves into the ground to prepare the ground for landscaping or other desired land improvements. The toothed plate is attached to a sub-plate that defines the width of the workable area of which the attachment assembly can work. The sub-plate is provided with a means of disengaging from the at least one toothed plate so that broken or worn parts can be quickly changed while in the field of operation, eliminating the need of having to go back to the shop for repair work.

Another feature of the present invention is a framed connection member that supports the sub-plate and is provided with a means of connecting to the work vehicle. In the most preferred embodiment, the framed connection member is provided with a connection part that allows the attachment assembly to be quickly removed from its corresponding connection member found on the front end of the work vehicle. The framed connection member is also preferably provided with a means of rolling the ground material in a forward manner and is provided with a safety shield for protecting the driver from falling debris.

More specifically, a tractor attachment assembly releaseably connected to a front end of a work vehicle for conditioning land includes an at least one toothed plate where the at least one toothed plate is provided with a plurality of conditioning teeth. A sub-plate is utilized to support the at least one toothed plate and a framed connection member is positioned to support the sub-plate when the sub-plate is under stress. The framed connection member is connectable to the front end of the work vehicle.

In another embodiment, a tractor attachment assembly releaseably connected to a front end of a work vehicle for conditioning land is provided with an at least one toothed plate where the at least one toothed plate is provided with a plurality of conditioning teeth. A sub-plate for supporting the at least one toothed plate is substantially flat and planarly aligned with the at least one toothed plate. And a framed connection member positioned to sustain the sub-plate when the sub-plate is under stress is also provided where the framed connection member is connectable to the front end of the work vehicle and the framed connection member is further provided with a means of rolling ground material when the attachment assembly is moved in a forward motion.

In yet another embodiment, a tractor attachment assembly releaseably connected to a front end of a work vehicle for conditioning land is provided where an at least one toothed plate is provided with a plurality of conditioning teeth and a sub-plate for supporting the at least one toothed plate is further provided with a means of disengaging from said sub-plate. The attachment assembly is also provided with a framed connection member positioned to support the sub-plate when the sub-plate is under stress. The framed connection member is connectable to the front end of the work vehicle.

### BRIEF DESCRIPTION OF THE DRAWINGS

FIG. 1 is a front perspective view of an attachment assembly used on a front end of a work vehicle with a rolling hood.

FIG. 2 is top view of one toothed plate that is provided with a means of disengaging from a sub-plate.

FIG. 3 is a rear view of the attachment assembly and illustrates at least one mechanism employed as a front-end loader quick disconnect hook-up system as it relates to a tractor.

FIG. 4 is a side view of the attachment assembly showing a support brace.

### DETAILED DESCRIPTION OF THE INVENTION

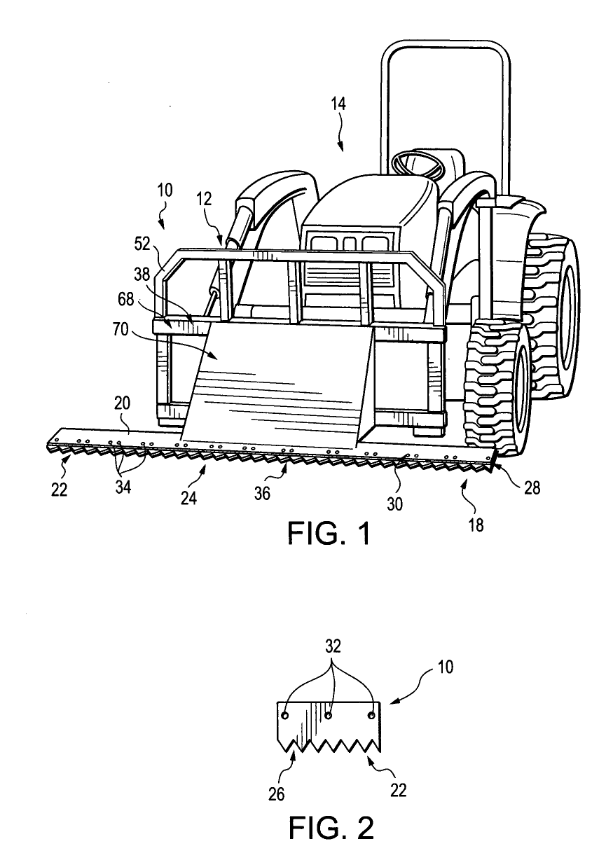

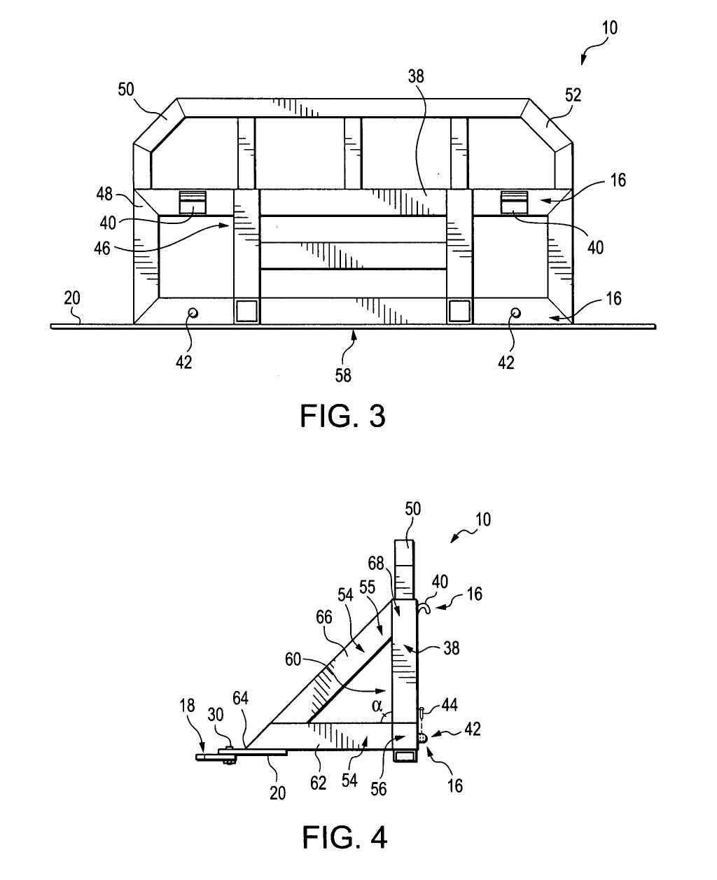

Referring to FIG. 1, an attachment assembly usable on a work vehicle for conditioning land is generally designated 10. The attachment assembly 10 is designed for being mounted to a front end 12 of a work vehicle 14 such as a tractor or bobcat, and is preferably provided with a front-end loader quick disconnect hook-up system 16 (as shown in FIGS. 3 and 4 and is discussed in greater detail later in this section) for rapid removal and connection of other compatible attachments. In this manner, the attachment assembly 10 is releaseably connected to the front end of the work vehicle for conditioning land.

Now referring to FIGS. 1 and 2, the attachment assembly 10 is provided with an at least one toothed plate 18 made of a durable material capable of tearing into small trees and shrubs several inches thick and digging into the ground made of various compositions normally found in nature. The toothed plate 18 is most preferably made of ¼ inch steel and is approximately 12 inches in width. The 12-inch toothed plates 18 are then mounted on a sub-plate 20 that are supportable to the at least one toothed plate 18. 12-inch toothed plates are the most preferred width because sub-plates 20 typically come in integrals of feet (or 12 inches), with sub-plate widths of 5 feet and 6 feet being the norm depending on the size of tractor or work vehicle 14 being used. The 12-inch toothed plate 18 makes it convenient to interchange plates when a various sizes of sub-plates 20 are employed; however it can be appreciated that the width of the toothed plate 18 may vary in size and not deviate from the spirit of the invention.

The at least one toothed plate 18 is provided with a plurality of conditioning teeth 22 that are horizontally aligned and extend toward a forward point 24 of the attachment assembly 10. The plurality of conditioning teeth 22 are of optimal length and of optimal width to strip small trees and shrubs several inches thick and separated sufficiently to provide a grooving gap 26 for etching grooves of multiple inches into workable ground. The optimal length and optimal width are further determined by the ability of the plurality of conditioning teeth 22 to effectively grab onto and pull or carry loose debris from a work site. In the preferred embodiment, the plurality of conditioning teeth 22 are of a triangular design. The optimal length in the preferred embodiment is further defined as from about 1 inch to 4 inches in length and the optimal width is further defined as from about 1 inch to 4 inches in width. In the most preferred embodiment, the optimal length is 2 inches and the optimal width is 2½ inches.

The sub-plate 20 used for supporting the at least one toothed plate 18 is substantially flat by design. The substantially flat design provides a means of driving the at least one toothed plate 18 into clumped dirt or clay. The substantially flat design also provides a means of raking the ground material in a forward and reverse manner when the attachment assembly 10 is placed in a down position (not shown). The current FIG. 1 illustrates the attachment assembly 10 in a lateral position as the at least one toothed plate 18 extend forwardly, whereas the down position is a manuevering of the attachment assembly 10 such that the at least one toothed plate 18 extend pointing towards the ground. The ground material can be soil, loose dirt or clay, sand, or other types of ground composition. This design optimizes time and utility of the attachment assembly 10 by providing a dual manner in evening out the ground material. In the most preferred embodiment, the sub-plate 20 extends outwardly to a length of about 10 inches. In general, a longer extension provides more stability when carrying a load of material. However, deviations by several inches in either direction can provide a similar function. By shortening the length of the sub-plate 20, the attachment assembly 10 loses stability and by extending the length of the sub-plate 20, the sub-plate 20 becomes more prone to breakage.

The sub-plate 20 is preferably planarly aligned with the at least one toothed plate 18 so that a stabbing action can be achieved when driving the attachment assembly 10 forward or ramming the at least one toothed plate 18 into clumped soil or small trees and shrubs. The planar alignment does not require the sub-plate 20 to reside evenly with the at least one toothed plate 18, only that when the at least one toothed plate 18 is attached to the sub-plate 20, their respective planes are substantially parallel to each other.

Although the at least one toothed plate 18 is fixedly attached to the sub-plate 10, the sub-plate 20 is preferably provided with a means of disengaging from the at least one toothed plate 18 at a disengagement point 28 so that easy maintenance might be performed on the at least one toothed plate 18. In the preferred embodiment, the means of disengaging the sub-plate 20 from the at least one toothed plate 18 is provided by an at least one bolt and nut assembly 30. In the most preferred embodiment, three bolts are driven into a set of receiving holes 32 found on the at least one toothed plate 22 and fed through a set of corresponding sub-plate holes 34. Three corresponding nuts are then screwed onto each bolt until fastened securely up against an opposite surface 36 of where the three bolts were driven into. It is also preferred that the at least one bolt and nut assembly 30 is breakable at high stresses such that damage to the other parts of the attachment assembly 10 is prevented. In this manner, the at least one toothed plate 18 breaks off of the sub-plate 20 at the disengagement point 28 and can easily be replaced with a replacement toothed plate.

Now referring to FIGS. 3 and 4, a framed connection member 38 positioned to sustain the sub-plate 20 when the sub-plate 20 is under stress is also provided. The framed connection member 38 is connectable to the front end 12 of the work vehicle 14. In the preferred embodiment, the framed connection member 38 is connectable to a tractor by the quick disconnect hook-up system 16 that comprises of a set of gripping flanges 40 and a set of pin receivable securement studs 42. The set of gripping flanges 40 are placed onto a receiving hook (not shown) found on the front end 12 of the tractor and the attachment assembly 10 is pivoted into place by feeding the pin receivable securement studs 42 through a corresponding holding slot (not shown). The framed connection member 38 of the attachment assembly 10 is then secured to the front end 12 of the tractor by placing a holding pin 44 into the pin receivable securement stud 42 fed through on a back side of the holding slot.

The front-end loader quick disconnect hook-up system 16 for other work vehicles varies per work vehicle. The one previously described is found on a John Deer tractor. It is contemplated that the framed connection member 38 can be easily modified to suit the attachment requirements of other work vehicles 14 such as Caterpillar and the Bobcat just to name a few.

The framed connection member 38 is preferably comprised of 3 inch by 3 inch steel tubing that is ¼ inch thick. Individual linear tubes are welded together using a 3 pass weld technique well known in the art to ensure durability of the connections. The framed connection member 38 resembles a rectangular frame that is sufficiently wide and tall to support the connectable member parts of the quick disconnect hook-up system 16. The framed connection member 38 is reinforceable by adding additional steel tubing or trusses that can extend vertically, horizontally or diagonally within an inner area 46 located inside a perimeter 48 of the framed connection member 38.

The framed connection member 38 is optionally provided with a safety shield 50 designed to protect a driver from falling debris when the attachment assembly 10 is raised above the height of the work vehicle 14. The safety shield 50 is preferred to be of a webbed design which allows the driver to see the operations of the attachment assembly 10 while preventing large fragments of trees and shrubs from falling back on the driver. The safety shield 50 preferably extends perpendicularly from the plane of the sub-plate 20 and extends upwardly from the framed connection member 38. In the most preferred embodiment, the safety shield 50 is made from the same 3 inch by 3 inch steel tubing used in the framed connection member 38. By adding cross-section tubing inside an outside shield frame 52, a web-type shield is created that is extremely durable and transparent for optimal workability.

The framed connection member 38 is also provided with a support brace 54 that extends outwardly towards the sub-plate 20. The support brace 54 is preferably comprised of 3 inch by 3 inch steel tubing and forms a right-triangle shaped support frame 55 that has a substantially 90 degree angled corner a positioned on a lower part 56 of the framed connection member 38. In the most preferred embodiment, two right-triangle shaped support frames 55 are positioned equidistant from a center point 58 on a front side 60 of the framed connection member 38. A lower member 62 of the right-triangle shaped support frame 55 extends perpendicularly from the framed connection member 38 and is welded onto the sub-plate 20 at an end point 64 using a 4-pass weld method. An angled support member 66 makes up the hypotenuse of the right-triangle shaped support frame 55 and is attached to an upper part 68 of the framed connection member 38. The angled support member 66 is welded to the lower member 62 above the end point 64 where the lower member 62 is welded onto the sub-plate 20. The support brace 54 provides extra integrity to the operation of the at least one toothed plate 18 and the sub-plate 20 when heavy loads are being lifted. Additional beams or steel tubing can be added to join the various components to increase durability within the framed connection member 38 and the support brace 54.

Now referring to FIGS. 1 and 4, the framed connection member 38 is optionally provided with a means of rolling ground material when the attachment assembly 10 is moved in a forward motion. The means of rolling ground material is best provided by a rolling hood 70 for turning pushed materials on top of each other when the attachment assembly 10 is in a down position (not shown) and the work vehicle 14 is moving forward. The rolling hood 70 preferably extends from the upper part 68 of the framed connection member 38 and is sloped to extend to the end point 64 on the sub-plate 20. In the most preferred embodiment, the rolling hood 70 resides on the angled support members 66 of the two right-triangle shaped support frames 55 to provide a support force behind the rolling hood 70.

While a particular embodiment of the present attachment assembly 10 has been described herein, it will be appreciated by those skilled in the art that changes and modifications may be made thereto without departing from the invention in its broader aspects and as set forth in the following claims.

1) A tractor attachment assembly releaseably connected to a front end of a work vehicle for conditioning land, the tractor attachment assembly comprising:
an at least one toothed plate, said at least one toothed plate is provided with a plurality of conditioning teeth;
a sub-plate for supporting said at least one toothed plate; and
a framed connection member positioned to support said sub-plate when said sub-plate is under stress, said framed connection member is connectable to the front end of the work vehicle.

2) The tractor attachment assembly of claim 1, wherein said plurality of conditioning teeth are horizontally aligned and extend toward a forward point of the tractor attachment assembly.

3) The tractor attachment assembly of claim 2, wherein said plurality of conditioning teeth are of a triangular design.

4) The tractor attachment assembly of claim 1, wherein said plurality of conditioning teeth are of optimal length and of optimal width to strip small trees and shrubs and separated sufficiently to provide a grooving gap for etching grooves into workable ground.

5) The tractor attachment assembly of claim 4, wherein said optimal length is further defined as from about 1 inch to 4 inches in length.

6) The tractor attachment assembly of claim 4, wherein said optimal width is further defined as from about 1 inch to 4 inches in width.

7) The tractor attachment assembly of claim 1, wherein said sub-plate is substantially flat and planarly aligned with said at least one toothed plate.

8) The tractor attachment assembly of claim 1, wherein said at least one toothed plate is further provided with a means of disengaging from said sub-plate.

9) The tractor attachment assembly of claim 8, wherein said means of disengaging said at least one toothed plate from said sub-plate is provided by an at least one bolt and nut assembly.

10) The tractor attachment assembly of claim 9, wherein said at least one bolt and nut assembly is breakable at high stresses such that damage to the other parts of the tractor attachment assembly is prevented.

11) The tractor attachment assembly of claim 1, wherein said framed connection member is further provided with a safety shield designed to protect a driver from falling debris when the tractor attachment assembly is raised above the height of the work vehicle.

12) The tractor attachment assembly of claim 11, wherein said safety shield extends perpendicularly from said sub-plate and extends upwardly from said framed connection member.

13) The tractor attachment assembly of claim 11, wherein said framed connection member is further provided with a rolling hood for turning pushed materials on top of each other when the tractor attachment is in a down position.

14) The tractor attachment assembly of claim 12, wherein said rolling hood is sloped to extend to an end point on said sub-plate.

15) A tractor attachment assembly releaseably connected to a front end of a work vehicle for conditioning land, the tractor attachment assembly comprising:
an at least one toothed plate, said at least one toothed plate is provided with a plurality of conditioning teeth;
a sub-plate for supporting said at least one toothed plate, said sub-plate is substantially flat and planarly aligned with said at least one toothed plate; and
a framed connection member positioned to sustain said sub-plate when said sub-plate is under stress, said framed connection member is connectable to the front end of the work vehicle, said framed connection member is further provided with a means of rolling ground material when the attachment assembly is moved in a forward motion.

16) The tractor attachment assembly of claim 15, wherein said means of rolling ground material when the attachment assembly is moved in a forward motion is provided by a rolling hood located on the framed connection member.

17) The tractor attachment assembly of claim 16, wherein said rolling hood resides on a plurality of angled support members.

18) The tractor attachment assembly of claim 15, wherein said framed connection member is further provided with a front-end loader quick disconnect hook-up system.

19) A tractor attachment assembly releaseably connected to a front end of a work vehicle for conditioning land, the tractor attachment assembly comprising:
an at least one toothed plate, said at least one toothed plate is provided with a plurality of conditioning teeth;
a sub-plate for supporting said at least one toothed plate, wherein said at least one toothed plate is further provided with a means of disengaging from said sub-plate; and
a framed connection member positioned to support said sub-plate when said sub-plate is under stress, said framed connection member is connectable to the front end of the work vehicle.

20) The tractor attachment assembly of claim 19, wherein said framed connection member is further provided with a rolling hood for turning pushed materials on top of each other when the tractor attachment is in a down position.
